(19) United States
(12) Patent Application Publication
(10) Pub. No.: US 2026/0197711 A1
(43) Pub. Date: Jul. 9, 2026

(54) Double-Layer Artificial Intelligence Engine to Prioritize Users During Mass Handovers

(71) Applicant: Dell Products L.P., Round Rock, TX (US)

(72) Inventors: Avinash Kumar, PATNA (IN); Mahesh Reddy Av, BANGALORE (IN); Shital Bhatiya, BANGALORE (IN)

(21) Appl. No.: 19/015,580

(22) Filed: Jan. 9, 2025

(51) Int. Cl. H04W 28/08; H04W 28/086

(52) U.S. Cl. CPC H04W 28/095; H04W 28/0861

(57) ABSTRACT

A system can use a first model to produce a first output that indicates a prediction of a mass handover event in a broadband cellular network. The system can use a second model to produce a second output that classifies respective user equipment of a group of user equipment according to a criticality criterion. The system can, based on the first output and the second output, adjust a centralized unit-decentralized unit mapping applicable to network equipment of the broadband cellular network to satisfy a network load balance criterion corresponding to maintaining at least a threshold network load balance and to satisfy a power usage criterion corresponding to maintaining at most a threshold power usage, to produce an adjusted centralized unit-decentralized unit mapping. The system can conduct broadband cellular communications via the network equipment according to the adjusted centralized unit-decentralized unit mapping.

### BACKGROUND

A broadband cellular network can facilitate communications by user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can use a first artificial intelligence model to produce a first output that indicates a prediction of a handover event in a broadband cellular network that satisfies a mass handover criterion representative of a handover of at least a threshold number of user equipment in the broadband cellular network. The system can use a second artificial intelligence model to produce a second output that classifies respective user equipment of a group of user equipment according to a criticality criterion applicable to define respective criticalities of the respective user equipment. The system can, based on the first output and the second output, adjust a centralized unit-decentralized unit mapping applicable to network equipment of the broadband cellular network to satisfy a network load balance criterion corresponding to maintaining at least a threshold network load balance and to satisfy a power usage criterion corresponding to maintaining at most a threshold power usage, to produce an adjusted centralized unit-decentralized unit mapping. The system can conduct broadband cellular communications via the network equipment according to the adjusted centralized unit-decentralized unit mapping.

An example method can comprise obtaining, by a system comprising at least one processor, a first output from a first artificial intelligence model, wherein the first output indicates a prediction of a handover event in a broadband cellular network that satisfies a mass handover function. The method can further comprise obtaining, by the system, a second output from a second artificial intelligence model, wherein the second output classifies respective user equipment according to a criticality function. The method can further comprise adjusting, by the system, a centralized unit-decentralized unit mapping of the broadband cellular network based on the first output and the second output, wherein the adjusting satisfies a network load balance function, wherein the adjusting satisfies a power usage function, and wherein the adjusting produces an adjusted centralized unit-decentralized unit mapping. The method can further comprise facilitating, by the system, broadband cellular communications according to the adjusted centralized unit-decentralized unit mapping.

An example non-transitory computer-readable medium can comprise instructions that, in response to execution, cause a system comprising a processor to perform operations. These operations can comprise producing a first output using a first artificial intelligence model that indicates a prediction of a handover event in a broadband cellular network. These operations can further comprise producing a second output using a second artificial intelligence model that classifies respective user equipment connected via the broadband cellular network. These operations can further comprise adjusting a centralized unit-decentralized unit mapping of base station equipment of the broadband cellular network based on the first output and the second output to satisfy a network load balance criterion and to satisfy a power usage criterion, and to produce an adjusted centralized unit-decentralized unit mapping. These operations can further comprise communicating broadband cellular traffic according to the adjusted centralized unit-decentralized unit mapping.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a double-layer artificial intelligence engine to prioritize users during mass handovers, in accordance with an embodiment of this disclosure;

FIG. 2 illustrates another example system architecture that can facilitate a double-layer artificial intelligence engine to prioritize users during mass handovers, in accordance with an embodiment of this disclosure;

FIG. 3 illustrates another example system architecture of a first layer, and that can facilitate a double-layer artificial intelligence engine to prioritize users during mass handovers, in accordance with an embodiment of this disclosure;

FIG. 4 illustrates another example system architecture of a random-forest-based handover classifier, and that can facilitate a double-layer artificial intelligence engine to prioritize users during mass handovers, in accordance with an embodiment of this disclosure;

FIG. 5 illustrates another example system architecture of a second layer, and that can facilitate a double-layer artificial intelligence engine to prioritize users during mass handovers, in accordance with an embodiment of this disclosure;

FIG. 6 illustrates another example system architecture of a dynamic centralized unit-distributed unit mapping, and that can facilitate a double-layer artificial intelligence engine to prioritize users during mass handovers, in accordance with an embodiment of this disclosure;

FIG. 7 illustrates another example system architecture that can facilitate a double-layer artificial intelligence engine to prioritize users during mass handovers, in accordance with an embodiment of this disclosure;

FIG. 8 illustrates an example process flow that can facilitate a double-layer artificial intelligence engine to prioritize users during mass handovers, in accordance with an embodiment of this disclosure;

FIG. 9 illustrates another example process flow that can facilitate a double-layer artificial intelligence engine to prioritize users during mass handovers, in accordance with an embodiment of this disclosure;

FIG. 10 illustrates another example process flow that can facilitate a double-layer artificial intelligence engine to prioritize users during mass handovers, in accordance with an embodiment of this disclosure;

FIG. 11 illustrates an example block diagram of a computer operable to execute an embodiment of this disclosure.

### DETAILED DESCRIPTION

### Overview

The present examples, generally relate to fifth generation (5G) Radio Access Network (RAN) technologies. It can be appreciated that the present techniques can be applied to other types of broadband cellular communications.

In 5G RAN, managing mass handovers (HOs) efficiently can be important for maintaining Quality of Experience (QoE) while minimizing power consumption. A mass handover can generally comprise a handover operation that encompasses or serves the purpose for a batch of devices or consumers requesting the handover or in necessity of it.

For example, during a major event like a concert or a sports match, thousands of users can physically move simultaneously, leading to a surge in handovers for their user equipment (UE). These events can cause frequent centralized unit-distributed unit (CU-DU) interactions and DU relocations as the network strives to maintain seamless connectivity. This high frequency of handovers can increase a complexity of managing the network, and can also significantly boost power utilization, creating a problem for network operators striving to balance performance with energy efficiency.

The present techniques can address this problem by facilitating a double-layered supervised learning algorithm to predict mass HOs and prioritize critical users during these events. By optimizing CU and DU mapping based on user criticality, reduced power utilization and enhanced QoE in high-density mobility scenarios can be achieved. It can be appreciated that where an example used herein refers to optimizing a metric or another superlative, that there can be examples where a satisfactory (but sub-optimal) metric can be used.

As used herein, a 5G RAN architecture can comprise centralized units (CUs) and distributed units (DUs) that handle various tasks to ensure seamless connectivity. Handovers (HO) can refer to the transfer of active connections from one base station to another as users move. Quality of Experience (QoE) can denote the overall performance of the network from the user's perspective, influenced by factors like latency, throughput, and reliability. Power utilization can refer to the energy consumed by the network infrastructure to maintain connectivity and performance.

A problem to be addressed by the present techniques can relate to how to minimize power utilization in high-frequency handover scenarios with complex CU-DU interactions in 5G RAN, while ensuring seamless connectivity for critical users during mass handovers?

Prior approaches can focus on static prioritization and manual load balancing, which can often result in suboptimal power utilization and compromised QoE during high mobility events. These prior approaches can lack the capability to dynamically predict and manage mass HOs, leading to increased power consumption and user dissatisfaction.

The present techniques can be implemented to facilitate a double-layered artificial intelligence (AI) engine framework to predict mass HOs and prioritize critical users, optimizing CU-DU mapping to reduce power consumption and enhance QoE. A first layer of an example AI engine can predict mass handover events using historical data on user mobility, handover patterns, and network load metrics. A second layer of the AI engine can classify users based on criticality, ensuring that essential users (e.g., defense officers, doctors, or a classification that can be achieved based on applications usage of the UE) are prioritized during handovers. CU-DU mappings can be dynamically adjusted in real-time to balance network load and minimize power usage.

The present techniques can facilitate a double-layered AI based engine to predict mass HOs and prioritize critical users in 5G RAN to optimize power utilization and resource usage. The present techniques can optimize power utilization and enhances QoE by ensuring seamless connectivity for critical users during mass HOs.

In some examples, the present techniques can be implemented in conjunction with edge computing to reduce latency and improve real-time decision-making, which can facilitate optimizing power utilization and connectivity.

CU-DU mappings can generally relate to a the functional split between the Centralized Unit (CU) and Distributed Unit (DU) in a 5G network architecture. This division can allow for a flexible deployment of network functions, and can optimize (or satisfactorily produce) performance based on specific requirements such as latency and bandwidth.

A centralized (CU) can handle higher layers of the protocol stack, including Radio Resource Control (RRC), Packet Data Convergence Protocol (PDCP), and Service Data Adaptation Protocol (SDAP). The CU can be responsible for tasks that require more processing power and can be located further from the radio access points, relative to tasks performed by the DU.

A distributed unit (DU) can manage lower layers, such as Medium Access Control (MAC), Radio Link Control (RLC), and Physical (PHY) layers. The DU can generally be located closer to the radio units than the CU to minimize latency, which can be crucial for real-time applications.

A CU-DU split can allow for efficient resource allocation and management, as one CU can control multiple DUs, which can facilitate scaling network operations while maintaining performance standards.

Quality of Experience (QoE) can be improved through CU-DU Adjustments. That is, adjusting CU-DU mappings can significantly enhance Quality of Experience (QoE) for users by optimizing network performance. This can be done as follows.
1. Latency Reduction: By placing DUs closer to end users, latency can be reduced or minimized, which can be critical for applications like gaming or video conferencing. For instance, if a DU processes data locally rather than routing it through a distant CU, response times can be drastically reduced.
2. Traffic Management: The CU can prioritize traffic based on application needs. For example, during peak usage times, the CU can allocate more resources to time-sensitive data streams, such as video calls or live broadcasts, ensuring these services maintain high performance even under heavy load.
3. Dynamic Resource Allocation: The architecture ca allow for dynamic adjustments based on real-time traffic conditions. If a particular area experiences high demand, the CU can redistribute resources among connected DUs to balance load effectively.

Dynamic CU-DU mapping can optimize resource allocation and load balancing during peak traffic. For example, there can be a scenario of a stadium during a live event, where the DU near the event can experience congestion due to high user density. An action can be taken to dynamically map a subset of high-priority users to a less congested CU-DU pair, even if it is slightly farther away (but has spare capacity). An outcome of this action can be reduced latency, lower packet drops, and sustained throughput for high-priority applications, resulting in improved Quality of Experience (QoE) for end users.

### Example Architectures

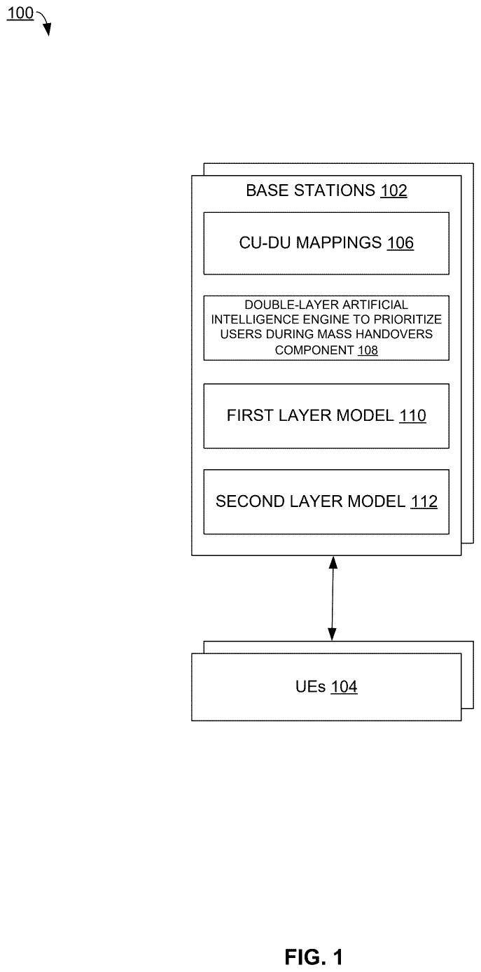

FIG. 1 illustrates an example system architecture 100 that can facilitate a double-layer artificial intelligence engine to prioritize users during mass handovers, in accordance with an embodiment of this disclosure.

System architecture 100 comprises base stations 102 and user equipment (UEs) 104. turn, base stations 102 comprises CU-DU mapping 106, double-layer artificial intelligence engine to prioritize users during mass handovers component 108, first layer model 110, and second layer model 112.

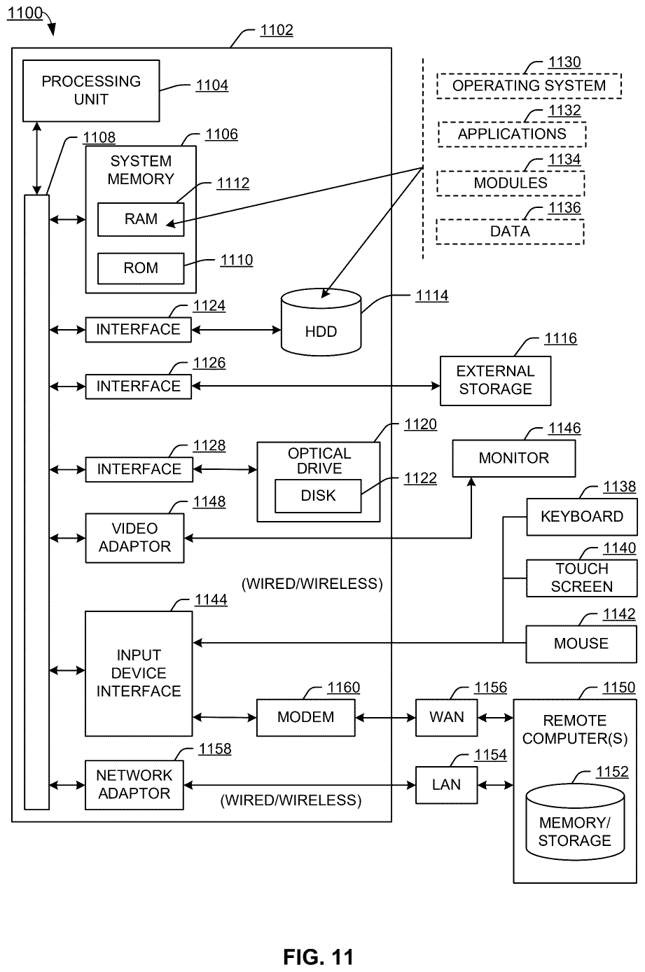

Each of base stations 102 and/or UEs 104 can be implemented with part(s) of computing environment 1100 of FIG. 11.

Base stations 102 can facilitate broadband cellular communications with one or more UEs of UEs 104. A UE can be attached to a particular base station, and during a handover event, the UE can be attached to a different base station (and no longer be attached to the first base station).

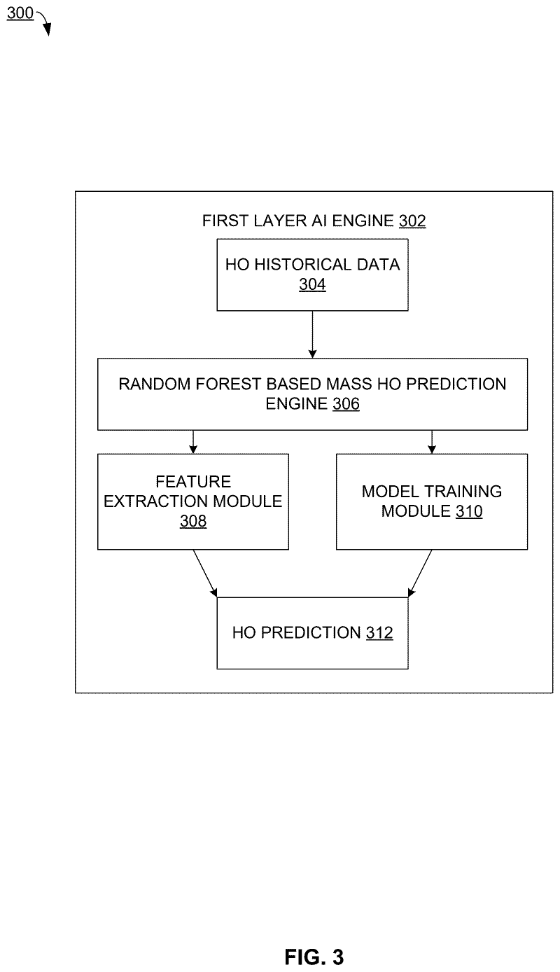

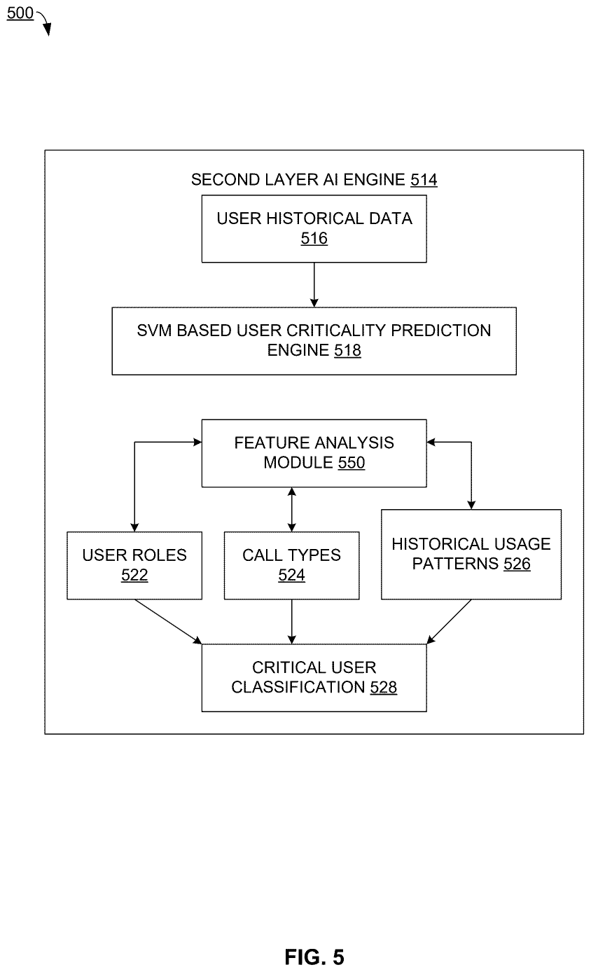

First layer model 110 can be similar to system architecture 300 of FIG. 3, and second layer model 112 can be similar to system architecture 500 of FIG. 5. Double-layer artificial intelligence engine to prioritize users during mass handovers component 108 can leverage first layer model 110 and second layer model 112 in determining how to adjust CU-DU mapping 106, and then base stations 102 can use the adjusted CU-DU mapping 106 in facilitating broadband cellular communications with UEs 104.

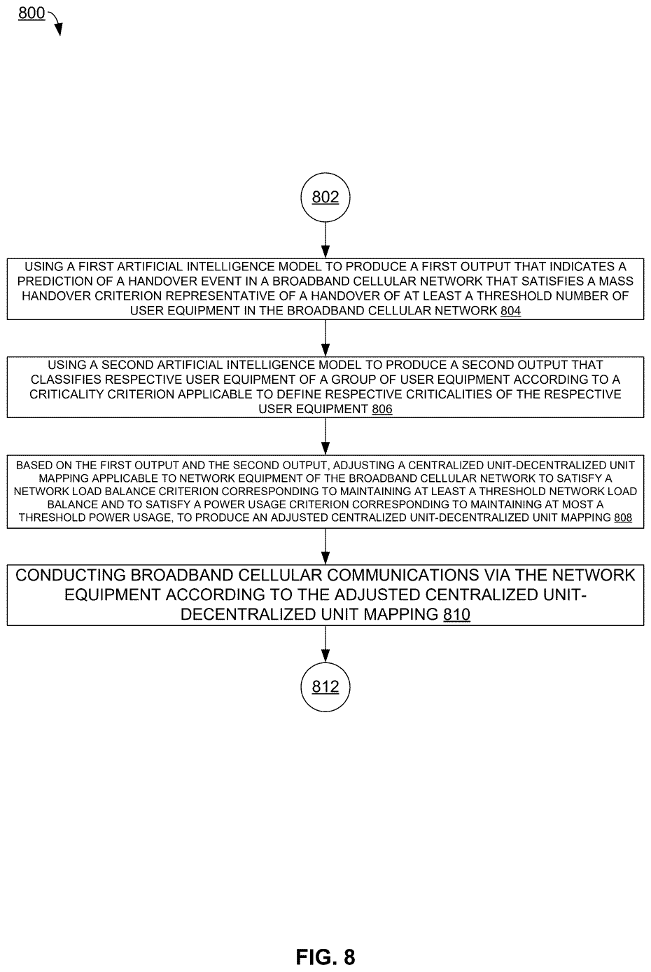

In some examples, double-layer artificial intelligence engine to prioritize users during mass handovers component 108 can implement part(s) of the process flows of FIGS. 8-10 to implement double-layer artificial intelligence engine to prioritize users during mass handovers.

It can be appreciated that system architecture 100 is one example system architecture for double-layer artificial intelligence engine to prioritize users during mass handovers, and that there can be other system architectures that facilitate a double-layer artificial intelligence engine to prioritize users during mass handovers.

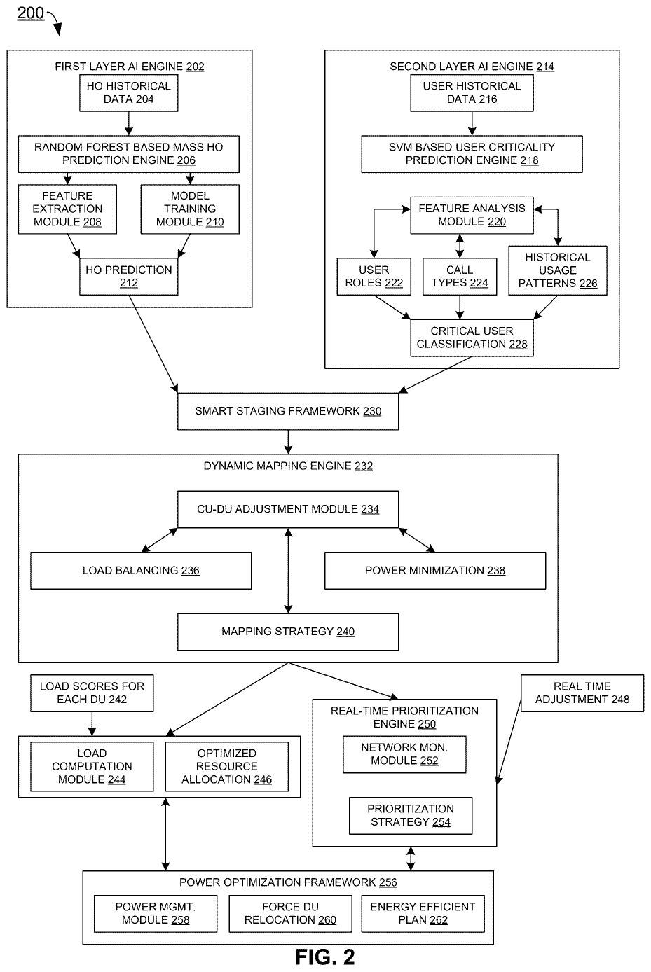

FIG. 2 illustrates another example system architecture 200 that can facilitate a double-layer artificial intelligence engine to prioritize users during mass handovers, in accordance with an embodiment of this disclosure. In some examples, part(s) of system architecture 200 can be implemented by part(s) of system architecture 100 of FIG. 1 to facilitate a double-layer artificial intelligence engine to prioritize users during mass handovers.

System architecture 200 comprises first layer AI engine 202, HO historical data 204, random forest based mass HO prediction engine 206, feature extraction module 208, model training module 210, HO prediction 212, second layer AI engine 214, user historical data 216, SVM based user criticality prediction engine 218, feature analysis module 220, user roles 222, call types 224, historical usage patterns 226, critical user classification 228, smart staging framework 230, dynamic mapping engine 232, CU-DU adjustment module 234, load balancing 236, power minimization 238, mapping strategy 240, load scores for each DU 242, load computation module 244, optimized resource allocation 246, real time adjustment 248, real-time prioritization engine 250, network monitoring module 252, prioritization strategy 254, power optimization framework 256, power management module 258, force DU relocation 260, and energy efficient plan 262.

FIG. 3 illustrates another example system architecture 300 of a first layer, and that can facilitate a double-layer artificial intelligence engine to prioritize users during mass handovers, in accordance with an embodiment of this disclosure. In some examples, part(s) of system architecture 300 can be implemented by part(s) of system architecture 100 of FIG. 1 to facilitate a double-layer artificial intelligence engine to prioritize users during mass handovers.

System architecture 300 comprises first layer AI engine 302, HO historical data 304, random forest based mass HO prediction engine 306, feature extraction module 308, model training module 310, and HO prediction 312.

The present techniques can leverage historical data on user mobility, handover patterns, network load metrics, and supervised learning techniques.

Training a first layer of the example AI engine for mass handover predictions can be implemented as follows. The first layer of the AI engine can involve training a supervised learning model, such as random forest, to predict mass handovers (HOs) based on historical data. This trained model can be leveraged to help in anticipating high-mobility events and optimizing network performance.

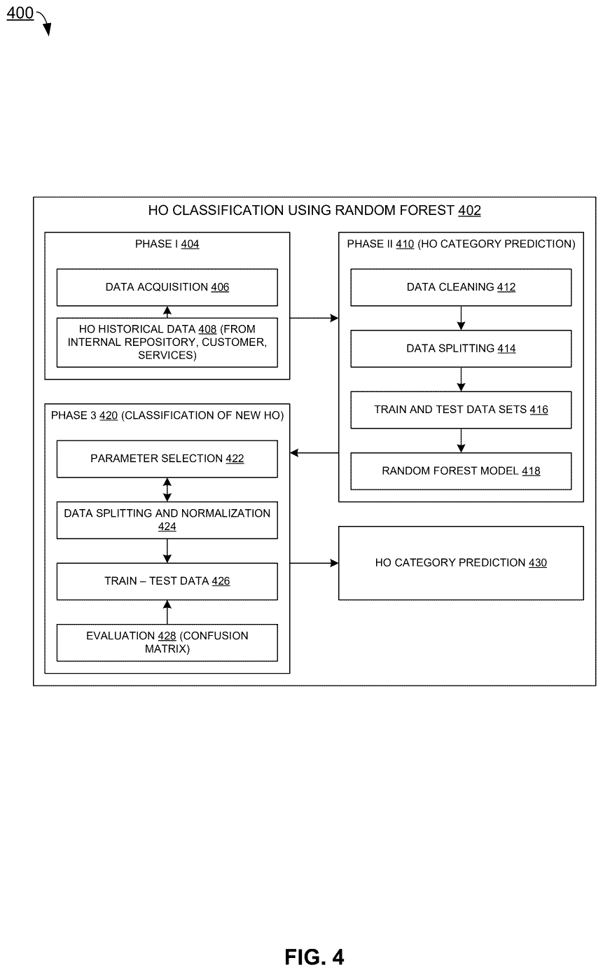

FIG. 4 illustrates another example system architecture 400 of a random-forest-based handover classifier, and that can facilitate a double-layer artificial intelligence engine to prioritize users during mass handovers, in accordance with an embodiment of this disclosure. In some examples, part(s) of system architecture 400 can be implemented by part(s) of system architecture 100 of FIG. 1 to facilitate a double-layer artificial intelligence engine to prioritize users during mass handovers.

System architecture 400 comprises HO classification using random forest 402, phase I 404, data acquisition 406, HO historical data 408 (from internal repository, customer, services), phase II 410 (HO category prediction), data cleaning 412, data splitting 414, train and test data sets 416, random forest model 418, phase 3 420 (classification of new HO), parameter selection 422, data splitting and normalization 424, train-test data 426, evaluation (confusion matrix), and HO category prediction 430.

In some examples, the following features can be used for training a model (e.g., a random forest model):
User Mobility Patterns: Tracks historical movement data of users across different network cells to identify common pathways and movement trends.
Handover Frequency: Measures the number of handovers occurring within specific time intervals or geographical areas, helping to pinpoint high-activity zones.
Network Load Metrics: Includes metrics such as bandwidth usage, number of active connections, and data throughput, which can influence the capacity and demand on network resources.
DU Utilization Rates: Monitors how frequently each Distributed Unit (DU) is utilized, indicating potential hotspots and areas under strain.
Historical DU Relocations: Records previous instances of DU relocations, which can provide insights into patterns and potential future relocations.
User Density: Calculates the number of users within a particular area or cell, aiding in predicting mass handovers based on high-density zones.
Received Signal Strength: Measures the strength and quality of the signal received by users, which impacts their likelihood of initiating a handover.
Time of Day: Considers the time-specific patterns of user movement and network load, as different times may exhibit varying handover behaviors.
Event-Specific Triggers: Includes data related to large-scale events, such as concerts or sports games, which often lead to significant spikes in handovers.
User Behavior Profiles: Analyzes individual user profiles, including their typical movement patterns and usage habits, typical application usage patterns, etc., to predict their handover behavior more accurately.

A model can be trained on selected features using historical application data to learn patterns associated with mass HOs. The model (such as a decision forest) can construct multiple decision trees during training and can aggregate their outputs to improve prediction accuracy. As new data is collected, the model can be updated (e.g., continuously) to refine its predictions. By leveraging diverse features, the model can effectively forecast mass HOs, identify potential hotspots, and support proactive network management.

FIG. 5 illustrates another example system architecture 500 of a second layer, and that can facilitate a double-layer artificial intelligence engine to prioritize users during mass handovers, in accordance with an embodiment of this disclosure. In some examples, part(s) of system architecture 600 can be implemented by part(s) of system architecture 100 of FIG. 1 to facilitate a double-layer artificial intelligence engine to prioritize users during mass handovers.

System architecture 500 comprises second layer AI engine 514, user historical data 516, SVM based user criticality prediction engine 518, feature analysis module 520, user roles 522, call types 524, historical usage patterns 526, and critical user classification 528.

In a double-layered AI engine framework according to the present techniques, the second layer can be responsible for classifying user criticality, such as into three example categories: PRIORITY USER, REGULAR USER and LOW PRIORITY USER. This classification can facilitate efficient prioritization during mass handovers (HOs) in 5G RAN environments, maintaining seamless connectivity for users based on their importance and network requirements.

A Support Vector Machine (SVM) technique can be implemented in the second layer to classify user criticality. SVM can generally handle high-dimensional data and perform well in both binary and multiclass classification tasks. A SVM technique can identify the optimal hyperplane that separates users into the three criticality categories (PRIORITY USER, REGULAR USER, and LOW PRIORITY USER.) based on the provided features.

Feature analysis according to the present techniques can be implemented as follows.

The classification techniques herein can leverage various features that can be indicative of a user's role, activity, and/or usage patterns. Such features can include:
User Roles: This can identify the primary function or ROLES of the user, such as defense officers, doctors, or civilians. This feature can also take into consideration UE category (e.g., as defined by a Third Generation Partnership Project) 3GPP standard) for device classification, such as mobile devices, fixed wireless access (FWA) devices, and Internet of Things (IoT) devices. Users with roles that require uninterrupted connectivity, like defense officers or medical personnel, can be classified as PRIORITY USER. Others, such as civilians, can fall under REGULAR or LOW criticality.
Call Types: The classification can consider the type of communication, such as emergency calls, video conferencing, or standard voice calls. Critical communication types, such as those involving life-critical services, can be classified as PRIORITY USER.
Historical Application Usage Patterns: The model analyzes the user's historical application usage. Frequent use of critical applications (e.g., telemedicine, emergency response systems) can categorize the user as PRIORITY USER, while regular applications can place the user in the REGULAR or LOW categories.

These features can be updated (e.g., continuously) to reflect a user's changing behaviors and roles, which can facilitate keeping the SVM model accurate and relevant.

The SVM can be trained on a labeled dataset where user criticality has been predefined as PRIORITY, REGULAR, or LOW. During training, the model can differentiate between these categories by identifying patterns and correlations within the dataset. The SVM model can minimize classification errors by adjusting the margin between different criticality levels, ensuring that users are accurately classified in real-time scenarios.

To classify user criticality into PRIORITY USER, REGULAR USER, or LOW PRIORITY USER, the SVM model can determine a decision function f(x), which can determine the distance of a data point (user) from the decision boundary (hyperplane). An example decision function is given by:

$$f ( x ) = w \cdot x + b$$

Where:
   w is the weight vector learned during training.
   x represents the feature vector of the user (e.g., role, call type, application usage).
   b is the bias term.

An example approach to classification can be:
If f(x)>threshold1 the user is classified as PRIORITY USER
If threshold2<f(x)≤threshold1, the user is classified as REGULAR USER.
If f(x)≤threshold2, the user is classified as LOW PRIORITY USER.

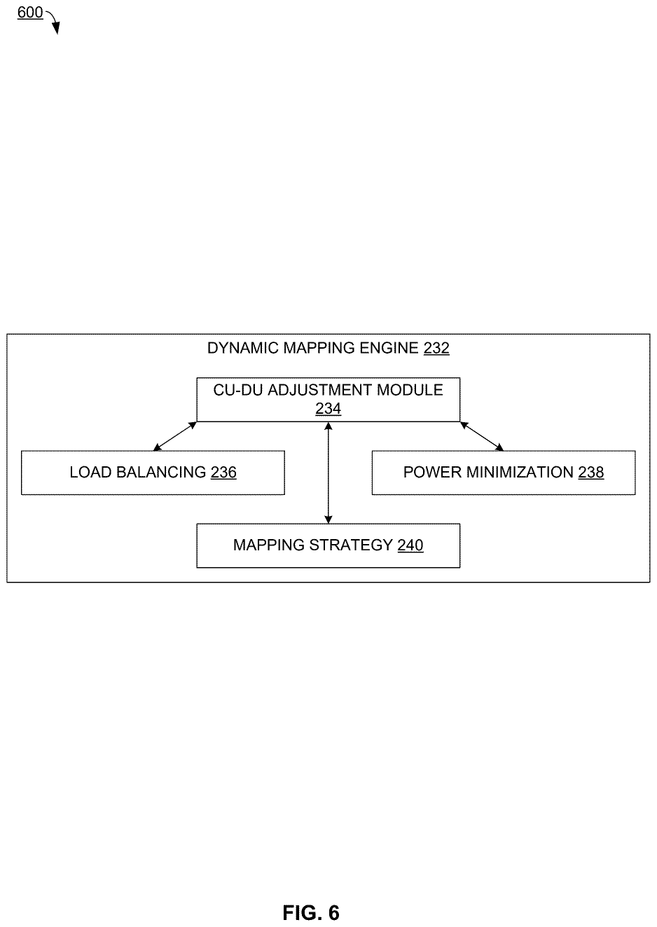

FIG. 6 illustrates another example system architecture 600 of a dynamic centralized unit-distributed unit mapping, and that can facilitate a double-layer artificial intelligence engine to prioritize users during mass handovers, in accordance with an embodiment of this disclosure. In some examples, part(s) of system architecture 600 can be implemented by part(s) of system architecture 100 of FIG. 1 to facilitate a double-layer artificial intelligence engine to prioritize users during mass handovers.

System architecture 600 comprises dynamic mapping engine 632, CU-DU adjustment module 634, load balancing 636, power minimization 638, and mapping strategy 640.

A dynamic CU-DU mapping phase can be as follows. Dynamic adjustment of CU-DU mapping can be performed during predicted mass HOs to balance load and minimize power consumption. In an example High critical users can be assigned to less loaded CUs and DUs, freeing up resources for high-priority users. This dynamic mapping can ensure that critical users experience seamless connectivity without overloading the network.

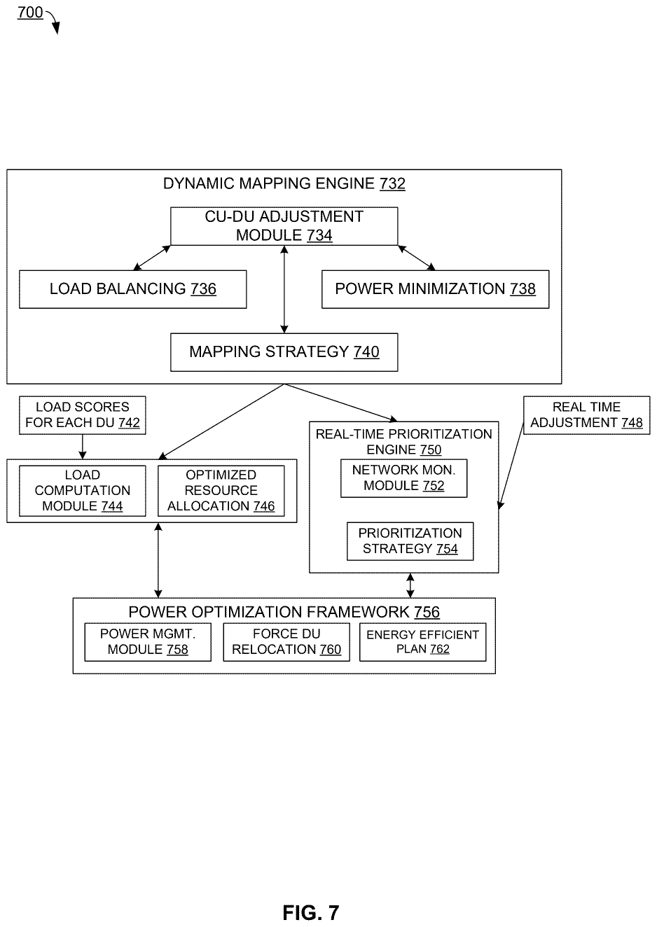

FIG. 7 illustrates another example system architecture 700 that can facilitate a double-layer artificial intelligence engine to prioritize users during mass handovers, in accordance with an embodiment of this disclosure. In some examples, part(s) of system architecture 700 can be implemented by part(s) of system architecture 100 of FIG. 1 to facilitate a double-layer artificial intelligence engine to prioritize users during mass handovers.

System architecture 700 comprises smart staging framework 730, dynamic mapping engine 732, CU-DU adjustment module 734, load balancing 736, power minimization 738, mapping strategy 740, load scores for each DU 742, load computation module 744, optimized resource allocation 746, real time adjustment 748, real-time prioritization engine 750, network monitoring module 752, prioritization strategy 754, power optimization framework 756, power management module 758, force DU relocation 760, and energy efficient plan 762.

A load score calculator component according to the present techniques can be implemented as follows. In a double-layered AI engine framework, a Load Score Calculator Component can play a role in managing and optimizing the distribution of network load across Distributed Units (DUs). By calculating a load score for each DU, a system that implements the present techniques can ensure efficient resource allocation and prevent any single DU from becoming a bottleneck during high-traffic scenarios like mass handovers (HOs) in 5G RAN environments.

The load score for each DU can be calculated based on a combination of various metrics that reflect its current utilization and performance. These metrics can include:
Active Connections (AC): The number of active user connections currently being handled by the DU. Higher active connections can indicate a higher load.
Bandwidth Utilization (BU): The percentage of the total available bandwidth that is currently being used by the DU. This metric can facilitate understanding how much data traffic the DU is managing.
Processing Capacity (PC): The central processing unit (CPU) and memory utilization of the DU, reflecting how much of its computational resources are being consumed. High processing capacity utilization can suggest that the DU is nearing its operational limits.
Handover Rate (HR): The rate at which handovers are being processed by the DU. A higher handover rate can indicate increased load due to frequent user mobility.
Historical Load Patterns (HLP): The historical load trends of the DU, which can provide insights into how the DU has handled traffic over time. This can help in predicting potential future load spikes.
Latency (L): The current latency experienced by users connected to the DU. Increased latency can be an indicator of a DU struggling under high load.

The load score Ls can be computed using a weighted sum of these metrics:

$$Ls = w 1 \times AC + w 2 \times BU + w 3 \times PC + w 4 \times HR + w 5 \times HLP + w 6 \times L$$

Where:
w1,w2, . . . , w6 are the weights assigned to each metric, reflecting their relative importance in determining the overall load on the DU.

Real-time prioritization according to the present techniques can be implemented as follows. In a framework according to the present techniques, a real-time prioritization component can continuously monitor network conditions and user mobility patterns to make instantaneous (or sufficiently fast) decisions during mass handovers (HOs). The real-time prioritization component can real-time data, including user criticality levels, signal strength, and DU load scores, to dynamically adjust Centralized Unit (CU) to Distributed Unit (DU) mappings. Critical users, classified as PRIORITY USER, REGULAR USER, and LOW PRIORITY USER, based on their roles and service requirements, can be prioritized during handovers. This can ensure that high-priority users experience minimal latency and uninterrupted connectivity, even in congested network conditions. By dynamically reallocating resources, the system can prevent bottlenecks and maintains optimal Quality of Experience (QoE) for all users, particularly those deemed critical.

Power utilization optimization can be implemented as follows. A power utilization optimization component can actively minimize power consumption by forecasting mass handovers (HOs) and dynamically adjusting Centralized Unit (CU) to Distributed Unit (DU) mappings. The power utilization optimization component can identify underutilized CUs during low-demand periods and powers them down, effectively reducing energy usage. Simultaneously, it can force DU relocations to CUs with available capacity, which can ensure that critical users maintain uninterrupted connectivity. By balancing the load across the network, this approach can prevent unnecessary power draw and extend the operational lifespan of the infrastructure. The system can continuously monitor user density and network load, adjusting power usage in real-time to maintain an optimal balance between energy efficiency and Quality of Experience (QoE). This dynamic power management strategy can contribute to significant reductions in operational costs and support sustainability goals in 5G RAN deployments.

### Example Process Flows

FIG. 8 illustrates another example process flow 800 that can facilitate a double-layer artificial intelligence engine to prioritize users during mass handovers, in accordance with an embodiment of this disclosure. In some examples, one or more embodiments of process flow 800 can be implemented by double-layer artificial intelligence engine to prioritize users during mass handovers component 108 of FIG. 1, or computing environment 1100 of FIG. 11.

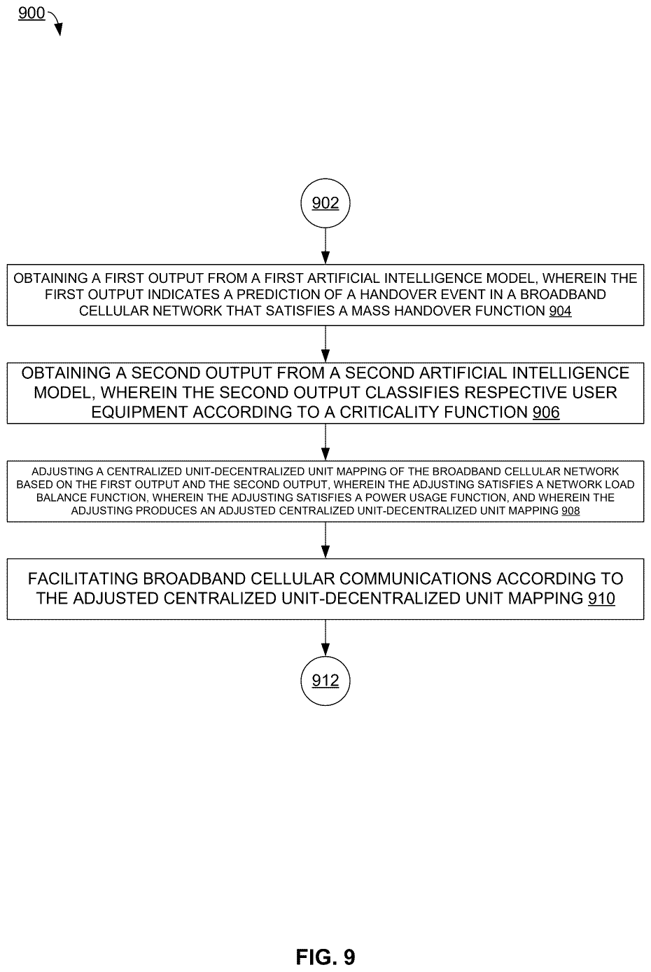

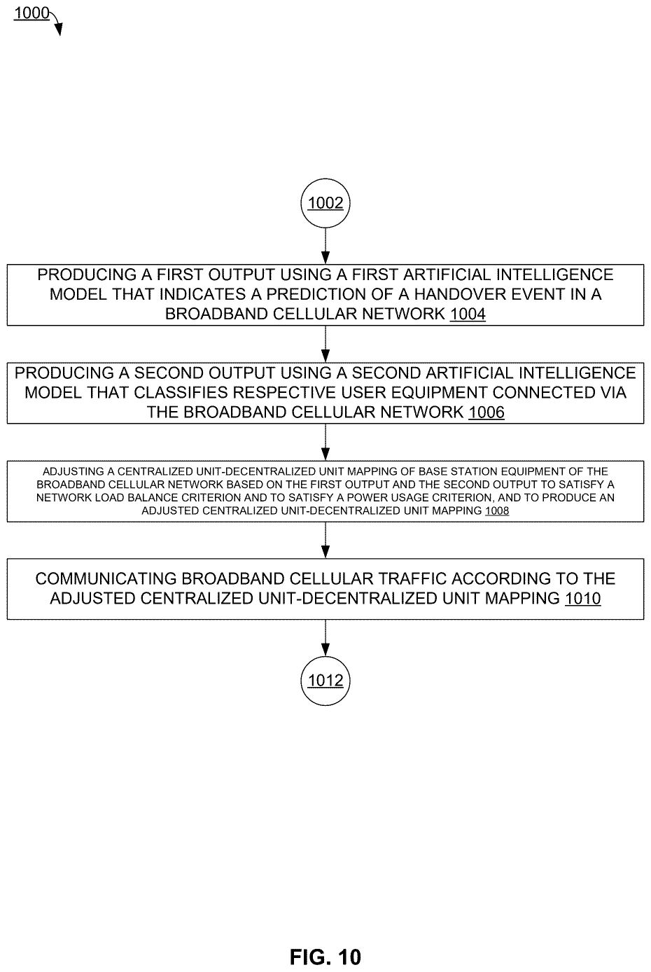

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 900 of FIG. 9, and/or process flow 1000 of FIG. 10.

Process flow 800 begins with 802, and moves to operation 804.

Operation 804 depicts using a first artificial intelligence model to produce a first output that indicates a prediction of a handover event in a broadband cellular network that satisfies a mass handover criterion representative of a handover of at least a threshold number of user equipment in the broadband cellular network. In some examples, the first artificial intelligence model can be similar to system architecture 300 of FIG. 3.

In some examples, the first artificial intelligence model implements a random forest technique. A random forest technique can generally comprise creating multiple decision trees during a training process. Then, during inference, a classification output for an input can be a classification determined by a majority of those decision trees.

In some examples, the first artificial intelligence model is trained based on data indicative of historical handover events with respect to the network equipment of the broadband cellular network. This can be similar to HO historical data 204 of FIG. 2.

After operation 804, process flow 800 moves to operation 806.

Operation 806 depicts using a second artificial intelligence model to produce a second output that classifies respective user equipment of a group of user equipment according to a criticality criterion applicable to define respective criticalities of the respective user equipment. In some examples, the second artificial intelligence model can be similar to system architecture 500 of FIG. 5.

In some examples, the second artificial intelligence model implements a support vector machine process. This can be similar to SVM based user criticality prediction engine 218 of FIG. 2. A SVM can generally comprise a supervised max-margin model that performs classification and/or regression analysis on input data, and can be different from a random forest technique.

In some examples, the second artificial intelligence model is trained based on data indicative of historical user equipment usage with respect to the network equipment of the broadband cellular network. This can be similar to user historical data 216 of FIG. 2.

In some examples, the second artificial intelligence model produces the second output based on respective user roles of the respective user equipment, respective call types of the respective user equipment, or respective historical usage patterns of the respective user equipment. This can be similar to user roles 222, call types 224, and/or historical usage patterns 226 of FIG. 2.

In some examples, the second output comprises respective classifications of the respective user equipment, and wherein the respective classifications are drawn from a group of classifications comprising a priority user classification, a regular user classification, and a low-priority user classification. This can be similar to critical user classification of FIG. 2.

After operation 806, process flow 800 moves to operation 808.

Operation 808 depicts, based on the first output and the second output, adjusting a centralized unit-decentralized unit mapping applicable to network equipment of the broadband cellular network to satisfy a network load balance criterion corresponding to maintaining at least a threshold network load balance and to satisfy a power usage criterion corresponding to maintaining at most a threshold power usage, to produce an adjusted centralized unit-decentralized unit mapping. This can be similar to network monitoring module 252 of FIG. 2 adjusting CU-DU mapping 106 of FIG. 1.

After operation 808, process flow 800 moves to operation 810.

Operation 810 depicts conducting broadband cellular communications via the network equipment according to the adjusted centralized unit-decentralized unit mapping. Using the example of FIG. 1, base stations 102 can use an adjusted CU-DU mapping 106 to facilitate broadband cellular communications with UEs 104.

After operation 810, process flow 800 moves to 812, where process flow 800 ends.

FIG. 9 illustrates an example process flow 900 that can facilitate a double-layer artificial intelligence engine to prioritize users during mass handovers, in accordance with an embodiment of this disclosure. In some examples, one or more embodiments of process flow 900 can be implemented by double-layer artificial intelligence engine to prioritize users during mass handovers component 108 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 800 of FIG. 8, and/or process flow 1000 of FIG. 10.

Process flow 900 begins with 902, and moves to operation 904.

Operation 904 depicts obtaining a first output from a first artificial intelligence model, wherein the first output indicates a prediction of a handover event in a broadband cellular network that satisfies a mass handover function. In some examples, operation 904 can be implemented in a similar manner as operation 804 of FIG. 8.

After operation 904, process flow 900 moves to operation 906.

Operation 906 depicts obtaining a second output from a second artificial intelligence model, wherein the second output classifies respective user equipment according to a criticality function. In some examples, operation 906 can be implemented in a similar manner as operation 806 of FIG. 8.

In some examples, the respective user equipment are respective first user equipment, the second artificial intelligence model is trained on a labeled dataset, and the labeled dataset comprises respective labels that comprise respective classifications of respective second user equipment. That is, an SVM model can be trained on a labeled dataset where user criticality has been predefined as PRIORITY, REGULAR, or LOW.

In some examples, the second artificial intelligence model produces the second output based on a weight vector learned during training of the second artificial intelligence model, based on a feature vector that corresponds to a user equipment of the respective user equipment, and based on a bias term. This can be similar to the decision function, f(x)=w·x+b, as described herein.

After operation 906, process flow 900 moves to operation 908.

Operation 908 depicts adjusting a centralized unit-decentralized unit mapping of the broadband cellular network based on the first output and the second output, wherein the adjusting satisfies a network load balance function, wherein the adjusting satisfies a power usage function, and wherein the adjusting produces an adjusted centralized unit-decentralized unit mapping. In some examples, operation 908 can be implemented in a similar manner as operation 808 of FIG. 8.

In some examples, adjusting the centralized unit-decentralized unit mapping is performed based on respective load values for respective distributed units of the broadband cellular network. That is, a load score for each DU can be determined based on a combination of various metrics that reflect its current utilization and performance.

In some examples, the respective load values are based on respective numbers of active user connections being handled by the respective distributed units, respective percentages of available bandwidth being used by the respective distributed units, respective processing utilizations of the respective distributed units, respective handover processing rates of the respective distributed units, respective historical load patterns of the respective distributed units, or respective latencies of the respective distributed units.

In some examples, the respective load values are based on respective weighted combinations of at least two of the respective numbers of active user connections, the respective percentages of available bandwidth, the respective processing utilizations, the respective handover processing rats, the respective historical load patterns, or the respective latencies.

After operation 908, process flow 900 moves to operation 910.

Operation 910 depicts facilitating broadband cellular communications according to the adjusted centralized unit-decentralized unit mapping. In some examples, operation 910 can be implemented in a similar manner as operation 810 of FIG. 8.

In some examples, operation 910 comprises prioritizing a handover of a user equipment of the respective user equipment during a handover event based on the second output indicating that the user equipment satisfies a prioritization function. That is, users, classified as PRIORITY USER, REGULAR USER and LOW PRIORITY USER, based on their roles and service requirements, can be prioritized during handovers.

After operation 910, process flow 900 moves to 912, where process flow 900 ends.

FIG. 10 illustrates another example process flow 1000 that can facilitate a double-layer artificial intelligence engine to prioritize users during mass handovers, in accordance with an embodiment of this disclosure. In some examples, one or more embodiments of process flow 1000 can be implemented by double-layer artificial intelligence engine to prioritize users during mass handovers component 108 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 800 of FIG. 8, and/or process flow 900 of FIG. 9.

Process flow 1000 begins with 1002, and moves to operation 1004.

Operation 1004 depicts producing a first output using a first artificial intelligence model that indicates a prediction of a handover event in a broadband cellular network. In some examples, operation 1004 can be implemented in a similar manner as operation 804 of FIG. 8.

In some examples, the handover event comprises a transfer of an active connection of a user equipment of the respective user equipment from first base station equipment of the base station equipment of the broadband cellular network to second base station equipment of the base station equipment of the broadband cellular network.

In some examples, the first artificial intelligence model is trained based on at least two of user equipment mobility patterns, handover frequency, network load metrics, distributed unit utilization rates, historical distributed unit relocations, user equipment density, received signal strength values, a time of day, event-specific triggers, or user behavior profiles.

After operation 1004, process flow 1000 moves to operation 1006.

Operation 1006 depicts producing a second output using a second artificial intelligence model that classifies respective user equipment connected via the broadband cellular network. In some examples, operation 1006 can be implemented in a similar manner as operation 806 of FIG. 8.

In some examples, the second artificial intelligence model operates on an input that comprises respective roles of the respective user equipment. This can be similar to user roles 222

In some examples, the second artificial intelligence model operates on an input that comprises respective call types of the respective user equipment. This can be similar to call types 224.

In some examples, the second artificial intelligence model operates on an input that comprises respective historical application usage patterns of the respective user equipment. This can be similar to historical usage patterns 226.

After operation 1006, process flow 1000 moves to operation 1008.

Operation 1008 depicts adjusting a centralized unit-decentralized unit mapping of base station equipment of the broadband cellular network based on the first output and the second output to satisfy a network load balance criterion and to satisfy a power usage criterion, and to produce an adjusted centralized unit-decentralized unit mapping. In some examples, operation 1008 can be implemented in a similar manner as operation 808 of FIG. 8.

After operation 1008, process flow 1000 moves to operation 1008.

Operation 1010 depicts communicating broadband cellular traffic according to the adjusted centralized unit-decentralized unit mapping. In some examples, operation 1010 can be implemented in a similar manner as operation 810 of FIG. 8.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base stations 102 and/or UEs 104.

In some examples, computing environment 1100 can implement one or more embodiments of the process flows of FIGS. 8-10 to facilitate a double-layer artificial intelligence engine to prioritize users during mass handovers.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
using a first artificial intelligence model to produce a first output that indicates a prediction of a handover event in a broadband cellular network that satisfies a mass handover criterion representative of a handover of at least a threshold number of user equipment in the broadband cellular network;
using a second artificial intelligence model to produce a second output that classifies respective user equipment of a group of user equipment according to a criticality criterion applicable to define respective criticalities of the respective user equipment;
based on the first output and the second output, adjusting a centralized unit-decentralized unit mapping applicable to network equipment of the broadband cellular network to satisfy a network load balance criterion corresponding to maintaining at least a threshold network load balance and to satisfy a power usage criterion corresponding to maintaining at most a threshold power usage, to produce an adjusted centralized unit-decentralized unit mapping; and
conducting broadband cellular communications via the network equipment according to the adjusted centralized unit-decentralized unit mapping.

2. The system of claim 1, wherein the first artificial intelligence model implements a random forest technique.

3. The system of claim 1, wherein the first artificial intelligence model is trained based on data indicative of historical handover events with respect to the network equipment of the broadband cellular network.

4. The system of claim 1, wherein the second artificial intelligence model implements a support vector machine process.

5. The system of claim 1, wherein the second artificial intelligence model is trained based on data indicative of historical user equipment usage with respect to the network equipment of the broadband cellular network.

6. The system of claim 1, wherein the second artificial intelligence model produces the second output based on respective user roles of the respective user equipment, respective call types of the respective user equipment, or respective historical usage patterns of the respective user equipment.

7. The system of claim 1, wherein the second output comprises respective classifications of the respective user equipment, and wherein the respective classifications are drawn from a group of classifications comprising a priority user classification, a regular user classification, and a low-priority user classification.

8. A method, comprising:
obtaining, by a system comprising at least one processor, a first output from a first artificial intelligence model, wherein the first output indicates a prediction of a handover event in a broadband cellular network that satisfies a mass handover function;
obtaining, by the system, a second output from a second artificial intelligence model, wherein the second output classifies respective user equipment according to a criticality function;
adjusting, by the system, a centralized unit-decentralized unit mapping of the broadband cellular network based on the first output and the second output, wherein the adjusting satisfies a network load balance function, wherein the adjusting satisfies a power usage function, and wherein the adjusting produces an adjusted centralized unit-decentralized unit mapping; and
facilitating, by the system, broadband cellular communications according to the adjusted centralized unit-decentralized unit mapping.

9. The method of claim 8, wherein the respective user equipment are respective first user equipment, wherein the second artificial intelligence model is trained on a labeled dataset, and wherein the labeled dataset comprises respective labels that comprise respective classifications of respective second user equipment.

10. The method of claim 9, wherein the second artificial intelligence model produces the second output based on a weight vector learned during training of the second artificial intelligence model, based on a feature vector that corresponds to a user equipment of the respective user equipment, and based on a bias term.

11. The method of claim 10, wherein adjusting the centralized unit-decentralized unit mapping is performed based on respective load values for respective distributed units of the broadband cellular network.

12. The method of claim 10, wherein the respective load values are based on respective numbers of active user connections being handled by the respective distributed units, respective percentages of available bandwidth being used by the respective distributed units, respective processing utilizations of the respective distributed units, respective handover processing rates of the respective distributed units, respective historical load patterns of the respective distributed units, or respective latencies of the respective distributed units.

13. The method of claim 11, wherein the respective load values are based on respective weighted combinations of at least two of the respective numbers of active user connections, the respective percentages of available bandwidth, the respective processing utilizations, the respective handover processing rats, the respective historical load patterns, or the respective latencies.

14. The method of claim 9, further comprising:
prioritizing, by the system, a handover of a user equipment of the respective user equipment during a handover event based on the second output indicating that the user equipment satisfies a prioritization function.

15. A non-transitory computer-readable medium comprising instructions that, in response to execution, cause a system comprising at least one processor to perform operations, comprising:
producing a first output using a first artificial intelligence model that indicates a prediction of a handover event in a broadband cellular network;
producing a second output using a second artificial intelligence model that classifies respective user equipment connected via the broadband cellular network;
adjusting a centralized unit-decentralized unit mapping of base station equipment of the broadband cellular network based on the first output and the second output to satisfy a network load balance criterion and to satisfy a power usage criterion, and to produce an adjusted centralized unit-decentralized unit mapping; and
communicating broadband cellular traffic according to the adjusted centralized unit-decentralized unit mapping.

16. The non-transitory computer-readable medium of claim 15, wherein the handover event comprises a transfer of an active connection of a user equipment of the respective user equipment from first base station equipment of the base station equipment of the broadband cellular network to second base station equipment of the base station equipment of the broadband cellular network.

17. The non-transitory computer-readable medium of claim 15, wherein the first artificial intelligence model is trained based on at least two of user equipment mobility patterns, handover frequency, network load metrics, distributed unit utilization rates, historical distributed unit relocations, user equipment density, received signal strength values, a time of day, event-specific triggers, or user behavior profiles.

18. The non-transitory computer-readable medium of claim 15, wherein the second artificial intelligence model operates on an input that comprises respective roles of the respective user equipment.

19. The non-transitory computer-readable medium of claim 15, wherein the second artificial intelligence model operates on an input that comprises respective call types of the respective user equipment.

20. The non-transitory computer-readable medium of claim 15, wherein the second artificial intelligence model operates on an input that comprises respective historical application usage patterns of the respective user equipment.
